(19) United States
(12) Patent Application Publication
(10) Pub. No.: US 2017/0251145 A1
(43) Pub. Date: Aug. 31, 2017

(54) PASSIVELY POWERED IMAGE CAPTURE AND TRANSMISSION SYSTEM

(71) Applicant: UNIVERSITY OF PITTSBURGH-OF THE COMMONWEALTH SYSTEM OF HIGHER EDUCATION, PITTSBURGH, PA (US)

(72) Inventors: MARLIN H. MICKLE (DECEASED), (US); ZIQUN ZHOU, PITTSBURGH, PA (US); KARA NICOLE-SIMMS BOCAN, NORTH HUNTINGDON, PA (US); VYASA SAI, PITTSBURGH, PA (US); AJAY OGIRALA, PITTSBURGH, PA (US); ERVIN SEJDIC, PITTSBURGH, PA (US); NICHOLAS G. FRANCONI, PITTSBURGH, PA (US)

(73) Assignee: UNIVERSITY OF PITTSBURGH-OF THE COMMONWEALTH SYSTE M OF HIGHER EDUCATION, PITTSBURGH, PA (US)

(21) Appl. No.: 15/511,782

(22) PCT Filed: Sep. 21, 2015
(86) PCT No.: PCT/US15/51140

§ 371 Date: Mar. 16, 2017

Related U.S. Application Data
(62) Division of application No. 62/053,939, filed on Sep. 23, 2014.
Application No. 62/053,939 is a division of application No. 61/201,025, filed on Dec. 5, 2008.

(51) Int. Cl. H04N 5/232; H02M 7/04; H04N 7/18

(52) U.S. Cl. CPC H04N 5/23241; H04N 7/183; H04N 5/23203; H02M 7/04

(57) ABSTRACT

A passively powered image capture device includes a remote execution unit structured to receive commands from a base station and an imaging device coupled to the remote execution unit. The imaging device is structured to be controlled by the remote execution unit based on the commands received by the remote execution unit. The passively powered image capture device also includes an antenna and energy harvesting circuitry coupled to the antenna, the remote execution unit and the imaging device. The energy harvesting circuitry is structured to convert RF energy received by the antenna to DC energy for powering the remote execution unit and the imaging device.

### CROSS-REFERENCE TO RELATED APPLICATIONS

This application claims priority under 35 U.S.C. §119(e) from U.S. provisional patent application No. 62/053,939, entitled “Passively Powered Image Capture and Transmission System” and filed on Sep. 23, 2014, and U.S. provisional patent application No. 62/210,025, entitled “Passively Powered Image Capture and Transmission System” and filed on Aug. 26, 2015, the contents of which are incorporated herein by reference.

### BACKGROUND OF THE INVENTION

1. Field of the Invention

The present invention pertains to image capture systems, and, in particular, to a passively powered image capture and transmission system.

2. Description of the Related Art

There are numerous situations where an image capture device, such as a digital camera, is used. For example, such devices are often to capture still and/or video images for security and/or surveillance purposes. As another example, such devices are frequently used to capture still and/or video images inside the body during medical procedures. To date, such devices have been powered actively by an on-board battery or wired connection to a power source such as a power outlet. Batteries need to be recharged frequently and can become defective over time. Wired connections are bulky and limit the mobility of the device, and pose an infection risk in medical implants.

### SUMMARY OF THE INVENTION

In one embodiment, a passively powered image capture device is provided that includes a remote execution unit structured to receive commands from a base station and an imaging device coupled to the remote execution unit. The imaging device is structured to be controlled by the remote execution unit based on the commands received by the remote execution unit. The passively powered image capture device also includes an antenna and energy harvesting circuitry coupled to the antenna, the remote execution unit and the imaging device. The energy harvesting circuitry is structured to convert RF energy received by the antenna to DC energy for powering the remote execution unit and the imaging device.

In another embodiment, an image capture and transmission system is provided that includes a base station having a processor and storing a program, wherein the base station is structured to generate and wirelessly transmit: (i) RF energy and (ii) a plurality of commands based on the program. The system also includes a passively powered image capture device that includes an antenna, a remote execution unit structured to receive the commands, and an imaging device coupled to the remote execution unit. The imaging device is structured to be controlled by the remote execution unit based on the commands received by the remote execution unit. The passively powered image capture device also includes energy harvesting circuitry coupled to the antenna, the remote execution unit and the imaging device. The energy harvesting circuitry is structured to convert the RF energy received by the antenna to DC power for powering the remote execution unit and the imaging device.

In still another embodiment, an image capture method is provided that includes wirelessly receiving: (i) RF energy, and (ii) a number of commands in a passively powered image capture device having a remote execution unit and an imaging device coupled to the remote execution unit, converting the RF energy into DC energy and using the DC energy to power the remote execution unit and the imaging device, and controlling the imaging device from the remote execution unit based on the commands received by the remote execution unit to capture data for one or more images.

### BRIEF DESCRIPTION OF THE DRAWINGS

FIG. 1 is a schematic block diagram of a passive image capture and transmission system according to an exemplary embodiment of the disclosed concept;

FIG. 2 is a schematic diagram of a passive image capture device according to a non-limiting exemplary embodiment of the disclosed concept;

FIG. 3 is a block diagram of a remote execution unit according to an exemplary embodiment of the disclosed concept;

FIG. 4 is a block diagram of a decoding module according to an exemplary embodiment of the disclosed concept;

FIG. 5 is a block diagram of a base station according to an exemplary embodiment of the disclosed concept; and

FIG. 6 is a flow diagram illustrating operation of the system of FIG. 1 according to an exemplary embodiment of the disclosed concept.

### DETAILED DESCRIPTION OF EXEMPLARY EMBODIMENTS

As used herein, the singular form of “a”, “an”, and “the” include plural references unless the context clearly dictates otherwise.

As used herein, the statement that two or more parts or elements are “coupled” shall mean that the parts are joined or operate together either directly or indirectly, i.e., through one or more intermediate parts or elements, so long as a link occurs.

As used herein, “directly coupled” means that two elements are directly in contact with each other.

As used herein, “fixedly coupled” or “fixed” means that two elements are coupled so as to move as one while maintaining a constant orientation relative to each other.

As used herein, the word “unitary” means a part is created as a single piece or unit. That is, a part that includes pieces that are created separately and then coupled together as a unit is not a “unitary” part or body.

As used herein, the statement that two or more parts or elements “engage” one another shall mean that the parts exert a force against one another either directly or through one or more intermediate parts or elements.

As used herein, the term “number” shall mean one or an integer greater than one (i.e., a plurality).

As used herein, the term “passively powered” shall mean that a device is powered by receiving radio frequency (RF) energy and converting that RF energy to DC energy, which DC energy is used to provide operating power for the various components of the device.

As used herein, the term “instruction set architecture” or “ISA” shall mean a specification of the full set instructions including machine language opcodes and native commands, implemented by a particular processor. One non-limiting example of an ISA is the well-known 8051 Instruction Set.

As used herein, the term “reduced instruction set architecture” or “RISA” shall mean a simplified instruction set consisting of a subset of the ISA for a particular processor.

As used herein, the term “remote execution unit” or “REU” shall mean a programmable, passively powered device that is structured to execute one or more programs by receiving RISA commands from a remote source and executing the received RISA commands.

Directional phrases used herein, such as, for example, and without limitation, top, bottom, left, right, upper, lower, front, back and derivatives thereof, relate to the orientation of the elements shown in the drawings and are not limiting upon the claims unless expressly recited therein.

As described in greater detail herein, the disclosed concept provides a low power, passive image capture and transmission system that employs an active control and storage block having a continuous power supply, and a low-power passive image capture block in wireless communication with the active block that is powered by harvesting energy from RF energy transmitted by the active block. Due to the availability of continuous power, the active block is able to function as a classical computer implementing a full ISA (e.g., the 8051 ISA). In order to enable low-power operation, the passive block includes a remote execution unit that implements a RISA. The active block stores program commands and transmits the program commands wirelessly to the passive block which, based on the received commands, is able to capture images and transmit those images back to the active block. In the exemplary embodiment described herein, the program to be executed by the passive block is stored in the active block and the commands are transmitted to the passive block one at a time using an asynchronous pulse width encoding scheme. The passive block executes the received commands and returns the results back to the active block using backscattering. The disclosed concept thus allows the passive block to operate using very little power, for example no more than 5 mW in the exemplary embodiment. This includes the power required by the imaging device 36 described herein and the REU 12 described herein. The power consumption of REU 12 is a function of the clock speed, requiring no more than 1 mW at 80 MHz and 50 uW at 1 MHz in the exemplary embodiment. This is included in the 5 mW upper bound estimate for the passive block of the exemplary embodiment described above.

FIG. 1 is a schematic block diagram of a passive image capture and transmission system 2 according to an exemplary embodiment of the disclosed concept. System 2 includes a base station 4 and a passive image capture device 6, each of which is described in greater detail herein. Base station functions as the “active block” of system 2, and passive image capture device 6 functions as the “passive block” of system 2. Thus, as described in greater detail herein, base station 4 is structured to store and wirelessly transmit program commands for enabling system 2 to capture images, and passive image capture device 6 is structured to receive commands from base station 4 and execute those commands in order to enable system 2 to capture images. In addition, base station 4 is structured to generate and wirelessly transmit RF energy, and passive image capture device 6 is structured to harvest DC operating power from the RF energy transmitted by base station 4.

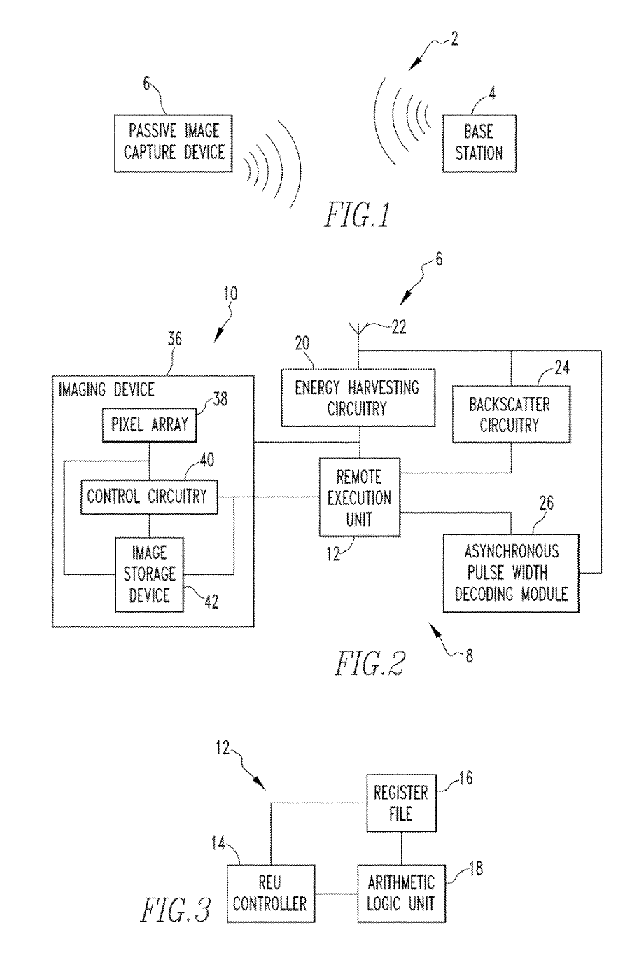

FIG. 2 is a schematic diagram of passive image capture device 6 according to a non-limiting exemplary embodiment of the disclosed concept. Passive image capture device 6 includes a front end portion 8 that is operatively coupled to and image capture portion 10.

As seen in FIG. 2, front end portion 8 includes a remote execution unit (REU) 12. REU 12 is structured to implement and execute a RISA, which may be, for example and without limitation, an 8051 RISA. Referring to FIG. 3, REU 12 includes an REU controller 14 that is operatively coupled to a register file 16 and an arithmetic logic unit 18. In the exemplary embodiment, REU controller 14 is modeled behaviorally as a sequential logic block based on a set of states for every instruction of the RISA implemented by REU 12, wherein under each state, a group of signals is either set or reset corresponding to the received instruction. Since, as described elsewhere herein, the program to be executed by REU 12 is stored in base station 4, the need for program memory in REU 12 is eliminated. Instead, the temporary storage on REU 12 in the form of a register file 16 is just enough to support the basic instructions of the RISA. Register file 16 is implemented as a sequential block that acts as a temporary data memory, and consists of a number of registers (e.g., 8-bit registers) that represent working registers and an accumulation register for REU 12. The arithmetic logic unit 18 is a module that is responsible for arithmetic and logic operations on received operands, each of which is implemented as a combinational block. In one particular non-limiting exemplary embodiment, REU is implemented as described in Sai et al., Low Power 8051-MISA-based Remote Execution Unit Architecture for IoT and RFID Applications, Int. J. Circuits and Architecture Design, Vol. 1, No. 1, 2013, pp. 4-19.

Front end portion 8 also includes energy harvesting circuitry 20 that is coupled to antenna 22. Energy harvesting circuitry 20 is structured to convert RF energy that is transmitted by base station 4 (as described elsewhere herein) and received by antenna 22 from to a DC voltage which is then used to provide operating power for front end portion 8 and image capture portion 10 of passive image capture device 6. Such energy harvesting technology is well known in the art and is described in, for example, and without limitation, U.S. Pat. Nos. 6,289,237, 6,615,074, 6,856,291, 7,057,514, and 7,084,605, the disclosures of which are incorporated herein by reference. In the exemplary embodiment, energy harvesting circuitry 20 comprises a matching circuit/charge pump combination that is coupled to antenna 22.

Front end portion 8 further includes backscatter circuitry 24 that is coupled to both REU 12 and antenna 22. Backscatter circuitry 24 is structured to enable passive image capture device 6 to transmit information back to base station 4 using well-known backscattering technology.

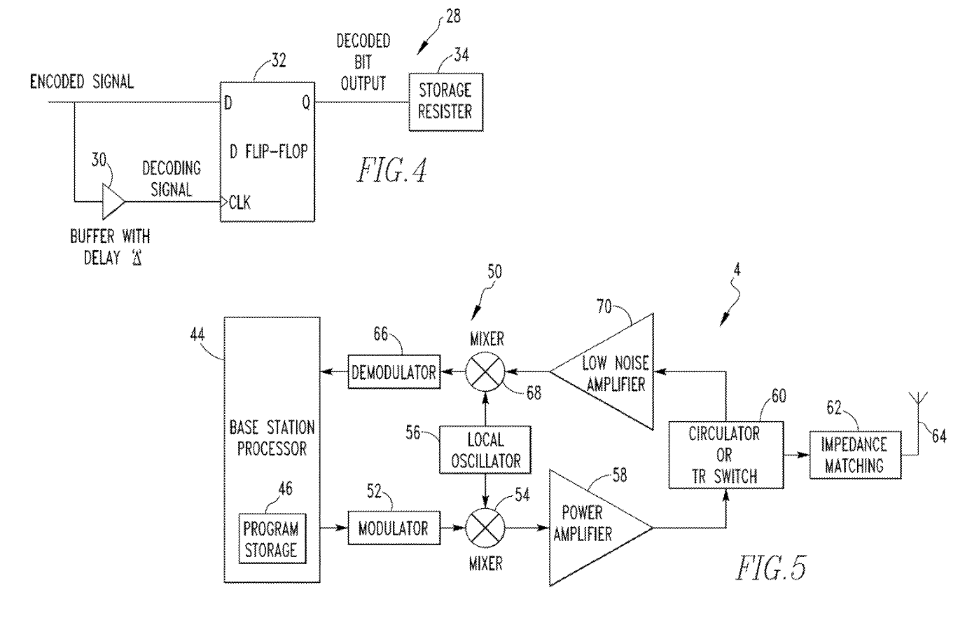

Front end portion 8 still further includes and asynchronous pulse width decoding module 26 that is structured to asynchronously decode information that is encoded and transmitted by base station 4. In the exemplary embodiment, the methodology for encoding and decoding information asynchronously that is employed by system 2 is described in U.S. Pat. No. 8,864,027, the disclosure of which is incorporated herein by reference. As described in that patent, the methodology includes a method of encoding a data signal that includes a plurality of first symbols (e.g., 0s) and a plurality of second symbols (e.g., 1s), wherein in the encoded signal each of the first symbols is represented by a first square wave having a first period Pₒ and a first duty cycle Dₒ and each of the second symbols is represented by a second square wave having a second period P₁ and a second duty cycle D₁, and wherein D₁>Dₒ and P₁≧Pₒ. The methodology further includes a method of decoding such an encoded signal by delaying the encoded signal by a predetermined amount of time Δ to create a decoding signal, sampling the encoded signal using the decoding signal, and determining the value of each of a plurality of decoded bits represented by the encoded signal based on the sampling. For this purpose, asynchronous pulse width decoding module 26 includes, in the non-limiting exemplary embodiment, a decoder circuit 28 as shown in FIG. 4 that may be used to decode an encoded signal that was encoded using the scheme just described. As seen in FIG. 4, decoder circuit 28 is implemented as a digital circuit, and includes a delay buffer 30 that introduces a time delay equal to Δ, a D flip-flop having D and clock (Clk) inputs and a Q output, and a storage register 34 (e.g., a shift register) that is coupled to the Q output of D flip-flop 32. The encoded signal to be decoded is fed to both the D input of D flip-flop 32 and the input of delay buffer 30. The output of delay buffer 30, which is the decoding signal described above, is fed to the clock (Clk) input of D flip-flop 32. In operation, with each rising edge of the decoding signal, (created by the delay buffer 30), the value (logic high or logic low) of the encoded signal will appear on the Q output of D flip-flop 32 as the decoded bit output. The decoded bit output is then stored in a serial manner in storage register 34. It should be noted that decoder circuit 28 does not need a clock signal, and thus consumes less power than a decoder that requires a high frequency clock signal.

As seen in FIG. 2, image capture portion 10 includes an imaging device 36 that is structured to capture and transmit digital images under the control of REU 12. In the exemplary embodiment, REU 12 and imaging device 36 each include a serial port interface (SPI) for this purpose. Also in the exemplary embodiment, image capture device is designed to capture 64×48 pixel black and white images and provide a digital image output in 8-bit/pixel grayscale or one-bit/pixel black-and-white format. Imaging device 36 includes a pixel array 38, control circuitry 40 coupled to pixel array 38, and an image storage device 42 (e.g., a suitable data buffer implemented in RAM) coupled to both pixel array 38 and control circuitry 40 (which may be an ASIC). To achieve better ambient light conditions, imaging device 36 may also include an LED light source (not shown). In the exemplary embodiment, pixel array 38 is an active-pixel sensor (APS) consisting of an integrated circuit containing an array of pixel sensors, with each pixel containing a photodetector and an active amplifier, and may be, for example and without limitation, a CMOS active pixel sensor. A suitable example of an imaging device 36 is the EM7760 ultra low-power CMOS optical sensor developed by EM Microelectronic-Marin SA.

FIG. 5 is a block diagram of base station 4 according to a non-limiting exemplary embodiment. Base station 4 includes a base station processor 44 which may be any suitable processing device that implements a full ISA, such as, for example, a microprocessor or a microcontroller. In one particular non-limiting exemplary embodiment, the RISA implemented by REU 12 is a subset of the ISA implemented by base station processor 44. For example, the ISA implemented by base station 44 may be the 8051 ISA, and the RISA implemented by REU 12 may be an 8051 RISA. Base station processor 44 also includes or is coupled to suitable program storage 46 (e.g., without limitation, RAM) which stores the program that is to be executed on REU 12. Base station 4 also includes a transmitting portion 48 and a receiving portion 50, both operatively coupled to base station processor 44. Transmitting portion 48 is structured to generate and wirelessly transmit RF operating power (for energy harvesting) and encoded command signals to passive image capture device 6, and receiving portion 50 is structured to receive and decode backscatter signals transmitted by passive image capture device 6. As seen in FIG. 5, transmitting portion 48 includes a modulator 52, a mixer 54 coupled to a local oscillator 56, a power amplifier 58, a circulator or TR switch 60, an impedance matching circuit 62, and an antenna 64. In the exemplary embodiment, modulator 52 is structured to encode signals using the asynchronous pulse width encoding scheme described elsewhere herein. As also seen in FIG. 5, receiving portion 50 includes a demodulator 66, a mixer 68 coupled to local oscillator 56, a low noise amplifier 70, and circulator or TR switch 60, impedance matching circuit 62 and antenna 64.

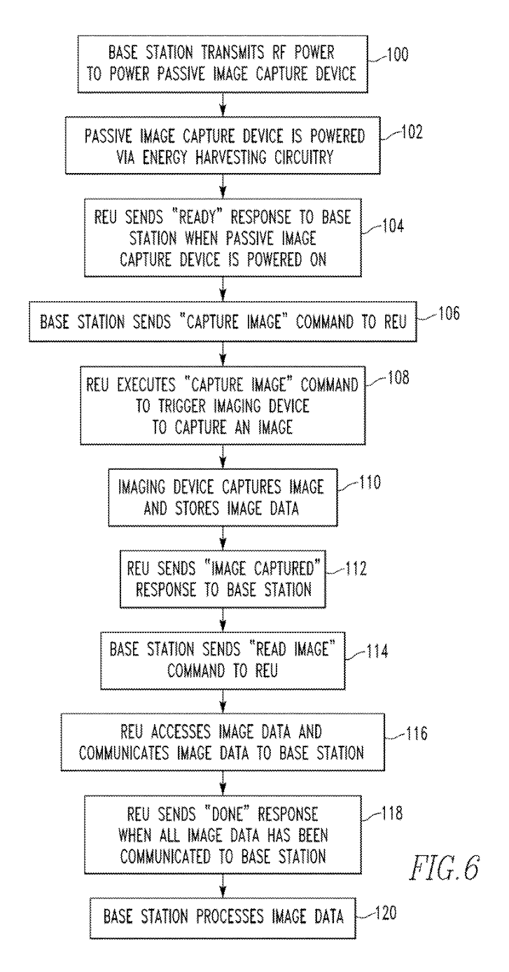

FIG. 6 is a flow diagram illustrating operation of system 2 according to an exemplary embodiment of the disclosed concept. The method begins at step 100, wherein base station 4 transmits RF power and code to passive image capture device 6. At step 102, passive image capture device 6 is powered via energy harvesting circuitry 20. Then, at step 104, REU 12 sends a “READY” response to base station 4 when passive image capture device 6 is powered on. At step 106, base station 4 sends a “CAPTURE IMAGE” command to REU 12. In response, at step 108, REU 12 executes the “CAPTURE IMAGE” command to trigger imaging device 36 to capture an image. At step 110, imaging device 36 captures the image and stores the image data in image storage device 42. Next, at step 112, REU 12 sends an “IMAGE CAPTURED” response to base station 4. At step 114, base station 4 sends a “READ IMAGE” command to REU 12. In response, at step 116, REU 12 accesses the image data stored in image storage device 42 and communicates the image data to base station 4. At step 118, REU 12 sends a “DONE” response when all of the image data has been communicated to base station 4. Finally, at step 120, base station 4 processes the image data, which may include, for example and without limitation, displaying images on a screen, storing images to a database, sending images to users for monitoring, and processing images to detect objects/people in the images. As described elsewhere herein, each of the communications from base station 4 to passive image capture device 6 (i.e. the commands as sets of operation codes within the RISA) is encoded using the asynchronous pulse width encoding scheme described herein (the encoded signal is decoded at the passive image capture device 6 as described herein), and each of the communications from passive image capture device 6 to base station 4 (i.e., the responses) is transmitted via backscatter.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A passively powered image capture device, comprising:
a remote execution unit structured to receive commands from a base station;
an imaging device coupled to the remote execution unit, the imaging device being structured to be controlled by the remote execution unit based on the commands received by the remote execution unit;
an antenna; and
energy harvesting circuitry coupled to the antenna, the remote execution unit and the imaging device, the energy harvesting circuitry being structured to convert RF energy received by the antenna to DC energy for powering the remote execution unit and the imaging device.

2. The image capture device according to claim 1, wherein the commands are encoded according to an asynchronous encoding scheme, and wherein the image capture device further includes an asynchronous decoding module coupled to the remote execution unit for asynchronously decoding the commands.

3. The image capture device according to claim 2, wherein the asynchronous encoding scheme is an asynchronous pulse width encoding scheme, and wherein the asynchronous decoding module is an asynchronous pulse width decoding module.

4. The image capture device according to claim 1, further comprising backscatter circuitry coupled to the remote execution unit, the backscatter circuitry being structured to enable information to be transmitted by the image capture device by backscattering.

5. The image capture device according to claim 1, wherein the remote execution unit is structured to implement an 8051 reduced instruction set architecture.

6. The image capture device according to claim 1, wherein the imaging device includes a pixel array, control circuitry, and an image storage device.

7. An image capture and transmission system, comprising:
a base station having a processor and storing a program, the base station being structured to generate and wirelessly transmit: (i) RF energy and (ii) a plurality of commands based on the program; and
a passively powered image capture device that includes:
an antenna;
a remote execution unit structured to receive the commands;
an imaging device coupled to the remote execution unit, the imaging device being structured to be controlled by the remote execution unit based on the commands received by the remote execution unit; and
energy harvesting circuitry coupled to the antenna, the remote execution unit and the imaging device, the energy harvesting circuitry being structured to convert the RF energy received by the antenna to DC power for powering the remote execution unit and the imaging device.

8. The system according to claim 7, wherein the base station is structured to encode the commands according to an asynchronous encoding scheme, and wherein the image capture device further includes an asynchronous decoding module coupled to the remote execution unit for asynchronously decoding the commands.

9. The system according to claim 8, wherein the asynchronous encoding scheme is an asynchronous pulse width encoding scheme, and wherein the asynchronous decoding module is an asynchronous pulse width decoding module.

10. The system according to claim 7, wherein the image capture device further comprises backscatter circuitry coupled to the remote execution unit, the backscatter circuitry being structured to enable information to be transmitted by the image capture device to the base station by backscattering.

11. The system according to claim 7, wherein the remote execution unit is structured to implement an 8051 reduced instruction set architecture, and wherein the processor is structured to implement a full 8051 instruction set architecture.

12. The system according to claim 7, wherein the base station is structured to wirelessly transmit the commands one at a time.

13. An image capture method, comprising:
wirelessly receiving: (i) RF energy, and (ii) a number of commands in a passively powered image capture device having a remote execution unit and an imaging device coupled to the remote execution unit;
converting the RF energy into DC energy and using the DC energy to power the remote execution unit and the imaging device; and
controlling the imaging device from the remote execution unit based on the commands received by the remote execution unit to capture data for one or more images.

14. The image capture method according to claim 13, wherein the commands are encoded according to an asynchronous encoding scheme, and wherein the method further includes asynchronously decoding the commands.

15. The image capture method according to claim 14, wherein the asynchronous encoding scheme is an asynchronous pulse width encoding scheme.

16. The image capture method according to claim 13, further comprising transmitting the data for one or more images from the image capture device to a base station.

17. The image capture method according to claim 14, further comprising generating the RF energy and the commands at a base station having a processor and storing a program, and transmitting the RF energy and the commands from the base station, wherein the commands are based on the program.

18. The image capture method according to claim 17, wherein the commands are a plurality of commands that are transmitted one at a time.

19. The image capture method according to claim 1, wherein the remote execution unit is structured to implement an 8051 reduced instruction set architecture.
